(19) United States
(12) Patent Application Publication
(10) Pub. No.: US 2025/0299641 A1
(43) Pub. Date: Sep. 25, 2025

(54) CUSTOMIZABLE VENEER

(71) Applicant: AMI Industries, Inc., Colorado Springs, CO (US)

(72) Inventor: Ravindra Ramulu Kandukuri, Secunderabad (IN)

(21) Appl. No.: 19/013,831

(22) Filed: Jan. 8, 2025

(30) Foreign Application Priority Data
Mar. 21, 2024 (IN) 202411021582

(51) Int. Cl. G09G 3/34; B64D 11/00

(52) U.S. Cl. CPC G09G 3/344; B64D 11/0015; G09G 2380/12

(57) ABSTRACT

A system may include a first cabin component for an interior of an aircraft. The first cabin component comprising a first external surface and a first display device integrated into the first external surface. A system may include a first controller electrically coupled to the first display device, wherein the first controller comprises one or more processors configured to execute program instructions stored in memory, wherein the program instructions are configured to cause the one or more processors to: apply a first voltage to the first display device, wherein the first display device displays a first image corresponding to the first voltage; and apply a second voltage to the first display device, wherein the first display device displays a second image corresponding to the second voltage.

### CROSS-REFERENCE TO RELATED APPLICATION

The present application claims the benefit of Indian Provisional Patent No. 202411021582, filed Mar. 21, 2024, which is incorporated herein by reference in the entirety.

### BACKGROUND

Cabin interiors of vehicles such as aircraft are often covered with veneers, a thin decorative covering of wood or wood-like materials. Traditionally, once a veneer is installed in a cabin interior, there are few options to change or customize the veneer. Therefore, the veneer remains unchanged until it is replaced, such as during an aircraft refurbishment. Refurbishments are typically seldom performed during the lifetime of the aircraft, as the aircraft owner will typically wait until a return of investment of the aircraft or components of the aircraft before they refurbish the interior. Because of this, the aircraft interior may be furbished late in the life of the aircraft, if at all.

Passengers often want variety in their traveling experience, preferring cabin interiors that are updated or different from previous journeys over cabin interiors that are outdated or unchanged over time. However, because veneers are infrequently updated, the passengers may be forced to travel in outdated or unchanged cabin interiors, potentially making their travel less enjoyable. Therefore, there is a need for cabin interiors that can be easily updated to better satisfy the passenger experience.

### SUMMARY

In some aspects, the techniques described herein relate to a system including: a first cabin component for an interior of an aircraft including: a first external surface, a first display device integrated into the first external surface; and a first controller electrically coupled to the first display device, wherein the first controller includes one or more processors configured to execute program instructions stored in memory, wherein the program instructions are configured to cause the one or more processors to: apply a first voltage to the first display device, wherein the first display device displays a first image corresponding to the first voltage; and apply a second voltage to the first display device, wherein the first display device displays a second image corresponding to the second voltage.

In some aspects, the techniques described herein relate to a system, further including: a second cabin component for the interior of the aircraft including: a second external surface, the second external surface including a second display device integrated into the second external surface; and a second controller electrically coupled to the second display device, wherein the second controller includes one or more processors configured to execute program instructions stored in memory, wherein the program instructions are configured to cause the one or more processors to: apply the first voltage to the second display device, wherein the second display device displays the first image corresponding to the first voltage; and apply the second voltage to the second display device, wherein the second display device displays the second image corresponding to the second voltage.

In some aspects, the techniques described herein relate to a system, further including a main controller coupled to the first controller and the second controller, the main controller including one or more processors configured to execute program instructions stored in memory, wherein the program instructions are configured to cause the one or more processors to: transmit first voltage data correlated to the first image to the first controller; and transmit second voltage data correlated to the second image to the second display device.

In some aspects, the techniques described herein relate to a system, further including a user interface device configured to transfer first voltage data and second voltage data.

In some aspects, the techniques described herein relate to a system, wherein the first cabin component is a table, wherein the second cabin component is a cabinet.

In some aspects, the techniques described herein relate to a system, wherein the first cabin component satisfies Federal Aviation Requirements 14 C.F.R. § 25.853 and corresponding Appendix F.

In some aspects, the techniques described herein relate to a system, wherein the first display device integrated into the first external surface satisfies Federal Aviation Requirements 14 C.F.R. § 25.853 and corresponding Appendix F.

In some aspects, the techniques described herein relate to a system, wherein satisfying Federal Aviation Requirements 14 C.F.R. § 25.853 and corresponding Appendix F includes being self-extinguishing when tested vertically.

In some aspects, the techniques described herein relate to a system, wherein satisfying Federal Aviation Requirements 14 C.F.R. § 25.853 and corresponding Appendix F includes having an average burn length not exceeding 6 inches when tested vertically.

In some aspects, the techniques described herein relate to a system, wherein satisfying Federal Aviation Requirements 14 C.F.R. § 25.853 and corresponding Appendix F includes having an average flame time after removal of a flame source not exceeding 15 seconds when tested vertically.

In some aspects, the techniques described herein relate to a system, wherein satisfying Federal Aviation Requirements 14 C.F.R. § 25.853 and corresponding Appendix F includes having drippings that do not continue to flame for more than 3 seconds after falling when tested vertically.

In some aspects, the techniques described herein relate to a system, wherein the second image comprises an emergency exit instruction.

In some aspects, the techniques described herein relate to a system, wherein the program instructions are configured to identify a passenger and cause the one or more processors to change the first image to the second image based on a predetermined preferred image of the passenger.

In some aspects, the techniques described herein relate to a system, wherein the program instructions are configured to cause the one or more processors to obtain a trained artificial intelligence (AI) model and/or machine learning (ML) model and, based on passenger output data, infer the second image.

In some aspects, the techniques described herein relate to a system, wherein the trained artificial intelligence (AI) model and/or machine learning (ML) model is configured to recognize an emergency landing, and display a second image that includes an emergency instruction.

In some aspects, the techniques described herein relate to a method including: applying a first voltage to a first display device of a first cabin component of an aircraft; displaying a first image on a first display device corresponding to the first voltage; applying a second voltage onto a first display device; and displaying a second image on the first display device corresponding to the second voltage.

In some aspects, the techniques described herein relate to a method, further including, before applying the first voltage, transmitting a first voltage data corresponding to the first image to a first controller or a user interface device.

In some aspects, the techniques described herein relate to a method, wherein transmitting the first voltage data includes transmitting the first voltage data wirelessly.

In some aspects, the techniques described herein relate to a method, further including obtaining a trained artificial intelligence (AI) and/or machine learning (ML) model, and, based on passenger output data, infer the second image.

In some aspects, the techniques described herein relate to a method, wherein the trained artificial intelligence (AI) and/or machine learning (ML) model, and, based on aircraft data, infer that an emergency landing has been made, and infer the second image as an emergency instruction.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1 illustrates a conceptual view of a system that includes a veneer capable of changing patterns and/or images, in accordance with one or more embodiments of the disclosure.

FIG. 2 illustrates a conceptual view of the system for controlling display devices on multiple cabin components, in accordance with one or more embodiments of the disclosure.

FIG. 3A illustrates an environment that includes an aircraft cabin 304 that includes a business conference room, in accordance with one or more embodiments of the disclosure.

FIG. 3B illustrates the environment of FIG. 3A during an emergency, in accordance with one or more embodiments of the disclosure.

FIG. 4 illustrates a passenger seating environment for an aircraft cabin that includes two passenger seats, in accordance with one or more embodiments of the disclosure.

FIG. 5 is a flow diagram illustrating a method for changing an image upon a first cabin component, in accordance with one or more embodiments of the disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

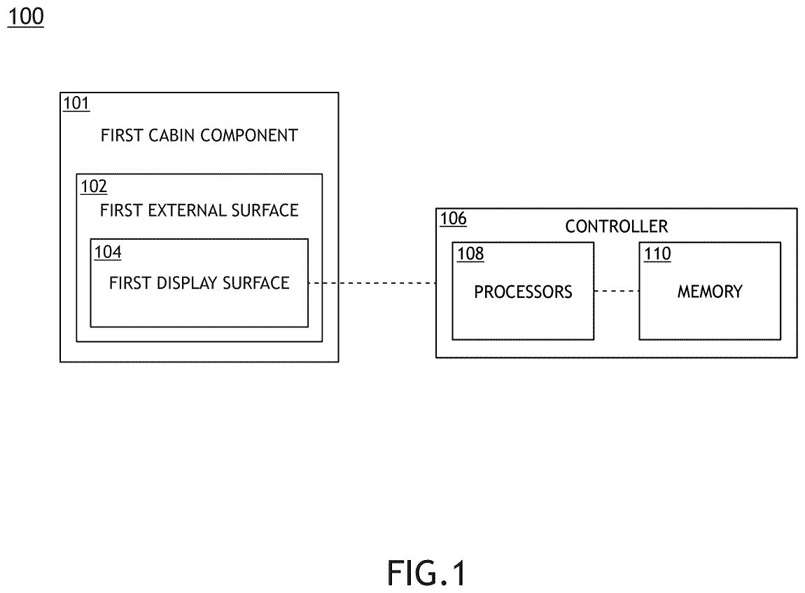

FIGS. 1 through 5 generally illustrate embodiments of a system and method for changing a veneer pattern on-board a vehicle, such as an aircraft, in accordance with one or more embodiments of the disclosure.

As used herein, the term “veneer” refers to covering, coating, or layer that is used to improve the esthetic appearance of an object over the material underneath. For example, a veneer may include a wood-like layer that covers a cabinet or shelf. In another example, a veneer may include a covering for a passenger seat. A veneer traditionally displays a wood pattern; however, a veneer may display any pattern or image in any color or shade of color. For example, a veneer may display a stone pattern, such as a granite pattern or a marble pattern. In another example, the veneer may display the logo of an aircraft company.

The veneer may also include information. For example, the veneer may provide information regarding the destination city (e.g., current weather, time, environmental conditions, physical conditions, local news, and tourism information, such as placed to visit). In another example, the veneer may include an interior scheme based on the travelers nature of work at the destination. For instance, the interior scheme may include a sport theme for a traveling sportsman. In another example, the veneer may include a scheme based on an airliner scheme preference. For instance, for a leased aircraft used by more than one airliner, the veneer may be changed to be a standard color, pattern, or image for the respective airliner currently operating the aircraft. In another example, the veneer may display emergency information or instructions during a time of emergency. For instance, during an emergency landing, the veneer may change to text instructing the passenger toward the nearest emergency exit. In another example, the veneer may display a message to fasten a safety belt.

Embodiments of the present disclosure are directed to cabin components within a vehicle that include a veneer on the surface of the cabin components that can change patterns or images based on an input (e.g., a specified voltage or electric field). The veneers from different cabin components may include controllers that are communicatively coupled so that multiple cabin components may be changed at one time, allowing an operator to change some or all of the veneers of the cabin in a coordinated manner. The veneer may include fire-proofing materials such that the veneer or the cabin component containing the veneer adequately conforms to fire safety rules and regulations.

FIG. 1 illustrates a conceptual view of a system 100 that includes a veneer capable of changing patterns and/or images, in accordance with one or more embodiments of the disclosure. In embodiments, the system 100 includes a first cabin component 101 (e.g., a table) having at least one first external surface 102 (e.g., a surface viewable by a passenger). The at least one external surface 102 includes at least one first display device 104 configured to display the veneer pattern. The first display device 104 is communicatively coupled to a first controller 106 (e.g. a first display device controller) that provides an input, such as a first voltage to the first display device 104. Once the first voltage is transmitted to the first display device 104, a veneer pattern forms on the first display device 104. The first cabin component 101 may include more than one external surface or side. The more than one external surface may include the first display device 104 or another display device 104 that is connected to the first controller 106. The first controller 106 may be configured to communicate with multiple first display devices 104. For example, the first controller 106 may be configured to communicate with the first display device 104 and another display device of the first cabin component. In another example, the first controller 106 may be configured to communicate with the first display device 104 of the first cabin component, and another display device of another component (e.g., an interior cabin panel).

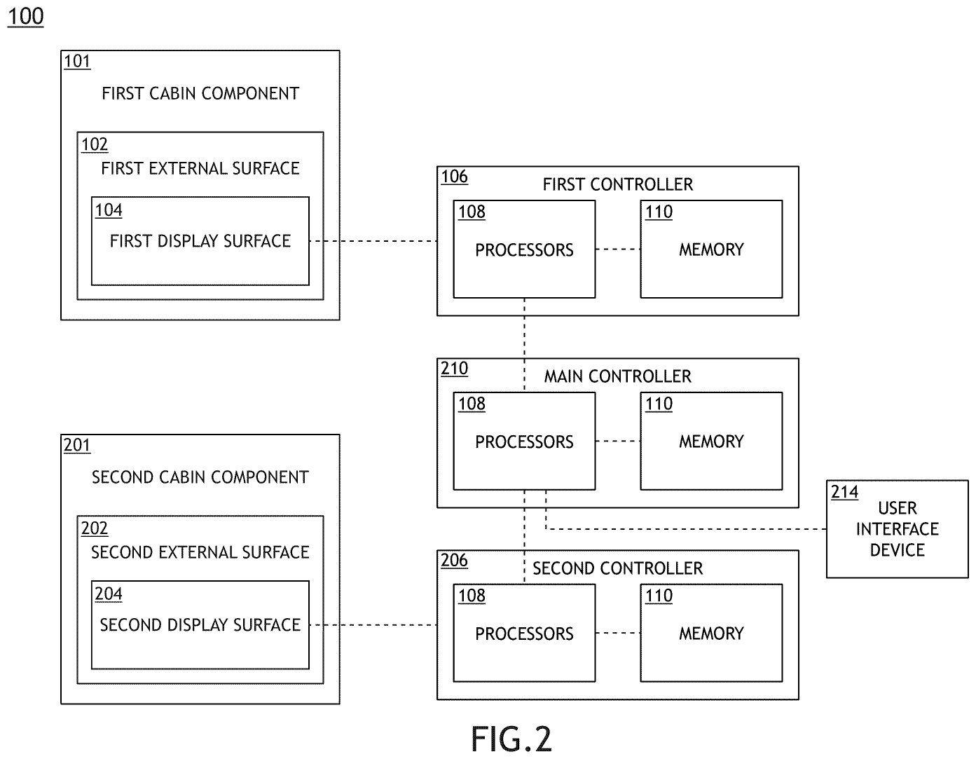

FIG. 2 illustrates a conceptual view of the system for controlling display devices on multiple cabin components, in accordance with one or more embodiments of the disclosure. In embodiments, the system 100 includes two or more cabin components (e.g., the first cabin component 101 and a second cabin component 201). For example, the second cabin component 201, similar to the first cabin component, may include an external surface (e.g., a second external surface 202), a display device (e.g., a second display device 204), and a second controller 206, the second controller communicatively coupled to the second display device 204.

In embodiments, the system 100 includes a main controller 210 communicatively coupled to one or more “local” controllers (e.g., the first controller 106 and the second controller 206). The main controller 210 coordinates the actions of the first controller and the second controller. For example, the main controller 210 may send updates, such as new pattern data, to the first controller 106 and the second controller 206.

In embodiments, the first controller 106, the second controller 206, and the main controller 210 each include one or more processors 108 and memory 110. For example, the memory 110 may maintain program instructions configured to cause the one or more processors 108 to carry out any of the one or more process steps described throughout the present disclosure (e.g., the one or more processors 108 are configured to execute program instructions stored in memory.

In embodiments, the one or more processors 108 of the first controller 106, the second controller 206, and/or main controller 210 are communicatively coupled to one or more display devices 104, 204 and/or one or more controllers 106, 206, 210. In this regard, the one or more processors 108 are configured to control the display of one or more patterns upon the first display device 104 or second display device 204.

In embodiments, the system 100 includes a user interface device 214 communicatively coupled to the one or more processors 108 of at least one of the first controller 106, the second controller 206, and the main controller 210. The user interface device 214 may be utilized by the first controller 106, the second controller 206, and the main controller 210 to accept information, selections, and/or instructions from a user. For example, a display may be used to display a pattern choice user (not shown). In turn, a user may input information, a selection, and/or instructions into the memory 110 of the controller 106 via the user interface device 214.

In embodiments, the first display device 104 and second display device 204 have electrodes and a fluid provided with electrically charged particles (e.g., capsules, or microcapsules of different colors), wherein the first display device 104 and second display device 204 operate according to the principle of electrophoresis. For example, during the use of the first display device 104 and second display device 204 an electric field is applied to electrodes within the first display device 104 and second display device 204, which affects an alignment of the electrically charged particles in the fluid, creating patterns, such as a veneer pattern.

In embodiments, the first display device 104 and second display device 204 are configured as a reflective display device. For example, the first display device 104 and the second display device 204 may include electrodes and a fluid provided with electrically charged particles. For example, the first display device 104 and second display device 204 may be configured such that, by applying an electric field once (e.g., a first voltage), a display (e.g., of a first image) is permanently displayed without the need for float voltage (e.g., once the first image is set, the pattern is stable without requiring energy to maintain the first image). In another example, first display device 104 and second display device 204 may be configured such that when the first image is displayed, the first display device 104 and/or second display device 204 may delete or change the first image (e.g., change the first image to a second image), by applying another electric field (e.g., a second voltage).

In embodiments, the first display device 104 and/or second display device may display, delete, or change a first image using E Ink or e-paper technology. E Ink or e-paper technologies are energy-saving technologies since they require the application of electrical energy only if the pattern or image to display is changed. Consequently, little to no energy is used during the standing time of the vehicle if the image displayed is static, which means that no energy is drawn from the vehicle battery or other power source. A description of E Ink technologies is described in U.S. Pat. No. 5,930,026 published Jul. 27, 1999, which is incorporated herein by reference in the entirety. A description of e-paper technologies is e-paper technologies U.S. Pat. No. 8,749,479B2 published Oct. 20, 2011, which is incorporated herein by reference in the entirety.

In embodiments, the first cabin component 101, the first external surface 102 (e.g., veneer) of the first cabinet component 101, and/or the first display device 104 of the first external surface 102 further include one or more fire resistant/retardant materials or coatings. For example, the first external surface 102 may include, but not be limited to, a flame-retardant coating, an integrated flame retardant, an intumescent coating, an additive that delays or suppresses ignition, a fire-suppressing binder, or a fire-suppressing filler.

In embodiments, the first cabin component 101, the first external surface 102 (e.g., veneer) of the first cabinet component 101, and/or the first display device 104 of the first external surface 102 meet, satisfy, and/or exceed aviation guidelines and/or standards defined for aircraft cabin interior structures or components installed in aviation environments. The aviation guidelines and/or standards, include those put forth by, but not limited to, the Federal Aviation Administration (FAA), the European Aviation Safety Agency (EASA) or any other flight certification agency or organization; the American National Standards Institute (ANSI), Aeronautical Radio, Incorporated (ARINC), or any other standards-setting organization or company; the Radio Technical Commission for Aeronautics (RTCA) or any other guidelines agency or organization; or the like. For example, and in embodiments, the first cabin component 101, the first external surface 102 of the first cabinet component, and/or the first display device 104 of the first external surface 102 are configured to satisfy flammability requirements of Federal Aviation Requirements (FAR) 14 C.F.R § 25.853 and corresponding Appendix F. Both documents (e.g., FAR C.F.R § 25.853 and corresponding Appendix F are incorporated by reference in their entirety. FAR 14 C.F.R § 25.853 and corresponding Appendix F describe flammability requirements and tests for aircraft interiors. Other regulations are also incorporated by reference in their entirety including 1) Airbus § ABD 0031: “Fire, smoke and toxicity specifications”, and 2) Boeing § D6-36440-Standard Cabin System Requirements Document, Volume 1.

As guidelines, regulations, and standards may change over time, the first cabin component 101, the first external surface 102 (e.g., veneer) of the first cabinet component 101, and/or the first display device 104 of the first external surface 102 may meet, satisfy, or exceed current guidelines, regulations, and standards, or guidelines, regulations, and standards of a specific version or year. For example, specific examples of the aviation guidelines and/or standards under 14 C.F.R. Part 25 and its Appendixes (e.g., 14 C.F.R. § 25.853, also found in FAA Advisory Circular (AC) 25.853-1, as entered with Amendment 25-83 on Feb. 2, 1995 and amended by Amendment 25-116 on Oct. 27, 2004). For instance, in embodiments, the first cabin component 101, the first external surface 102 of the first cabinet component 101, and/or the first display device 104 of the first external surface 102 meet, satisfy, or exceed the requirements set forth in the FAR 25.853 burn requirements tests including, but not limited to, the 14 C.F.R. § 25.853 Part II(a)(3) Oil Burner Test, the 14 C.F.R. § 25.853, Appendix F, Part I(b)(4) 12-Second Vertical Test, and/or the 14 C.F.R. § 25.853, Appendix F, Part I(b)(4) 60-Second Vertical Test.

In one non-limiting example, components of the first cabin component 101, the first external surface 102 (e.g., veneer) of the first cabinet component 101, and/or the first display device 104 of the first external surface 102 meet, satisfy, or exceed the requirements set forth in the FAR 25.853 burn requirements tests which require the first cabin component 101, the first external surface 102 of the first cabinet component 101, and/or the first display device 104 of the first external surface 102 be fabricated from materials that are self-extinguishing when tested vertically (e.g., exposed to a flame while located in a vertical orientation), where the average burn length is not to exceed 6 inches, the average flame time after removal of the flame source is not to exceed 15 seconds, and drippings from the test specimen are not to continue to flame for more than an average of 3 seconds after falling. It is noted herein FAR 25.853 may include additional tests with requirements the components of the first cabin component 101, the first external surface 102 (e.g., veneer) of the first cabinet component 101, and/or the first display device 104 of the first external surface 102 meet, satisfy, or exceed.

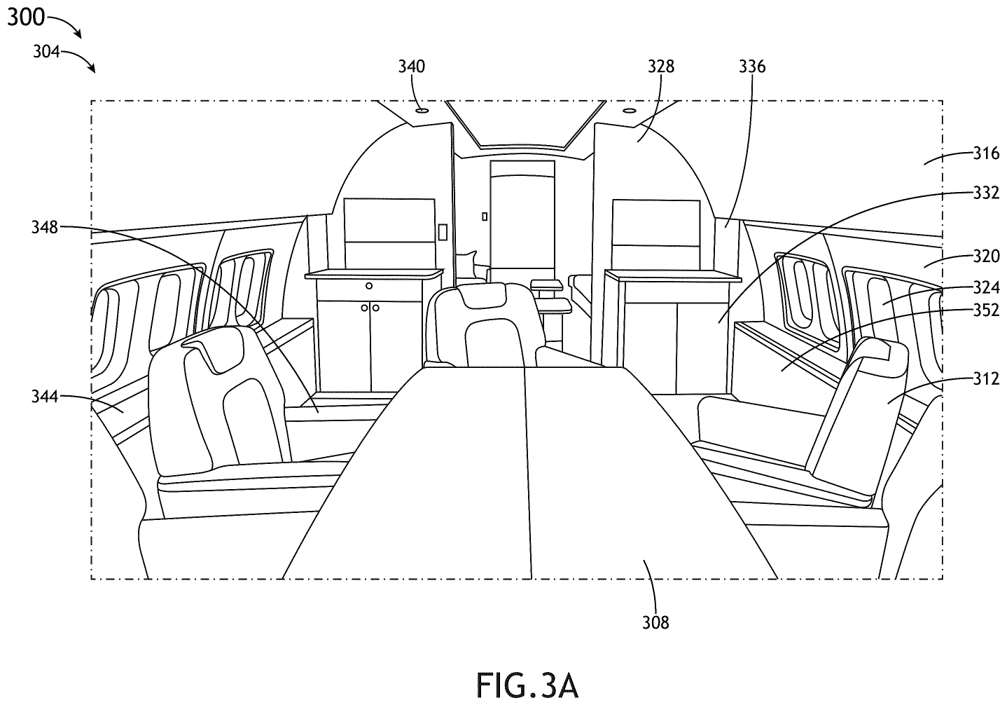

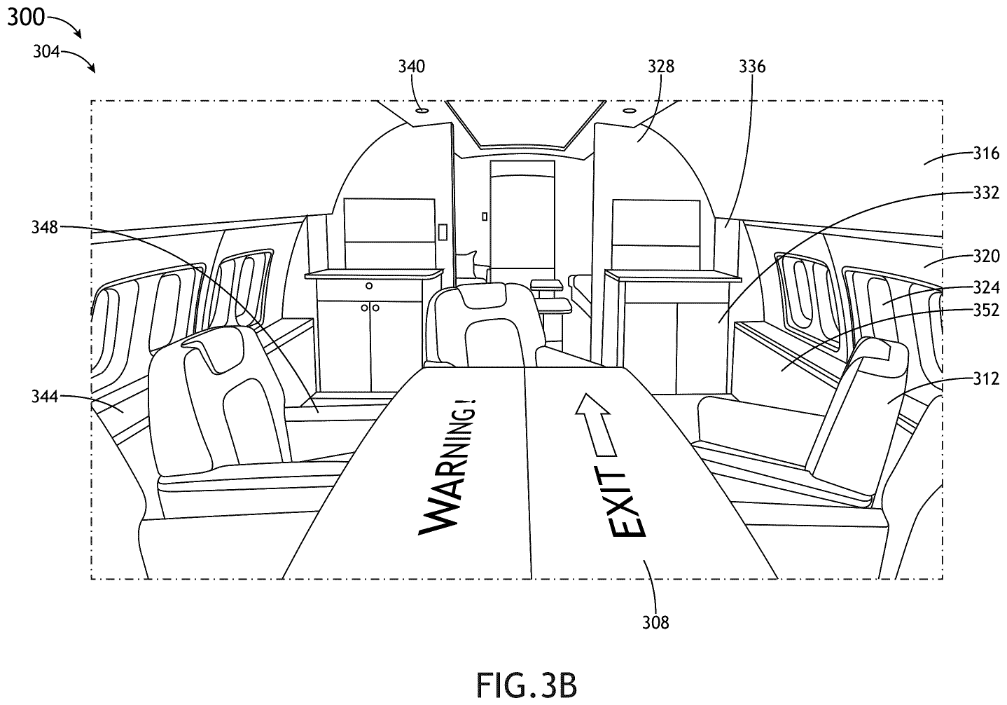

FIG. 3A illustrates an environment 300 that includes an aircraft cabin 304 that includes a business conference room, in accordance with one or more embodiments of the disclosure. The aircraft cabin 304 includes many items and surfaces that can be included within the system 100 as first cabin components 101 having first external surfaces 102 that can be integrated with first display devices 104 that can display a first image and second image (e.g., a first veneer image and a second veneer image). These items and surfaces include, but are not limited to, a table 308, a passenger seat 312, a ceiling, a window frame 320, a window, a bulkhead 328, a cabinet 332, a bar, a light fixture 340, a rail 344, a floor, and a wainscoting 352. The first controller, 106 or main controller, and/or user interface device 214 may be included within one of the one or more first cabin components 101. The main controller 210 and/or user interface device 214 may also be located remotely, such as in a flight attendant control panel, control room, or cockpit.

FIG. 3B illustrates the environment of FIG. 3A during an emergency, in accordance with one or more embodiments of the disclosure. The table 308 includes a veneer that is programmed to display emergency information, such as that the aircraft is in a dangerous situation (e.g., “warning”), and the direction towards the nearest exit. The veneer may display other information or instructions (e.g., text, colors, patterns) that would be helpful to the passenger in case of an emergency.

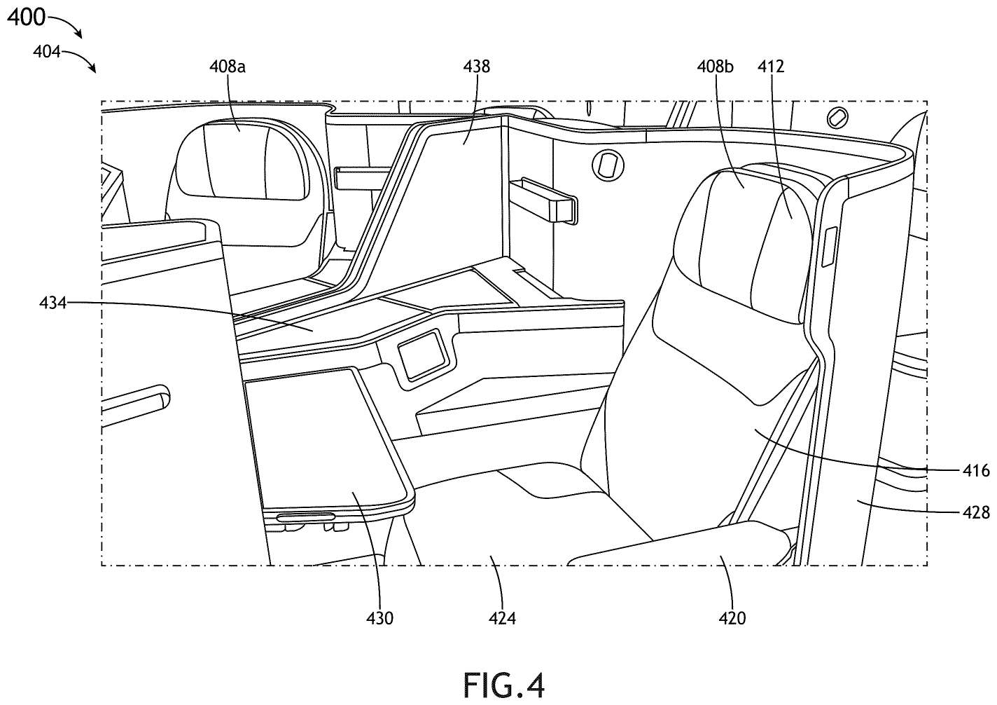

FIG. 4 illustrates a passenger seating environment 400 for an aircraft cabin 404 that includes two passenger seats 408a-b, in accordance with one or more embodiments of the disclosure. the passenger seating environment includes many items and surfaces that can be included within the system 100 as first cabin components 101 having first external surfaces 102 that can be integrated with first display devices 104 that can display a first image and a second image. These items and surfaces include but are not limited to a headrest 412, a seatback 416, an armrest 420, a seat pan 424, a shell surface 428, a tray table 430, a shelf 434, and a divider 438. Other items and surfaces include, but are not limited to panels, credenzas, monuments,

The system 100 of the current application enables an operator to change the appearance of a cabin interior without resorting to replacement of cabinet components. The veneer of the current application can be changed on a regular basis. For example, the veneer may be changed each time a passenger travels on the same aircraft.

The system 100 of the current application permits an operator to integrate a first display device 104 onto most any first external surface 102, as E Ink and e-paper sheets can be formed or cut into different shapes and sizes. The first display devices 104 can be integrated into nearly every type of first external surface 102 such as glass and plastic. In some embodiments, protection layers can be added to the display devices to protect the image-changing aspects of the first display devices 104. The first display device 104 may be embodied as a matrix display device (e.g., such as the matrix display devices used in e-Readers) or as a segmented display device (e.g., such as the segmented display devices used in E Ink displays)

In embodiments, integrating the first display device 104 into the first external surface 102 includes bonding the first display device 104 to the first cabinet component 101. For example, the first display device 104 may be glued to the first cabinet component 101 via an adhesive. In another example, the first display device 104 is formed onto the first cabinet component 101, such as via a vacuum form process.

In embodiments, the first display device 104 is integrated into more than one plane, or curve of the first cabin component 101 (e.g., the first display device covers a 3D portion of the first cabin component 101. For example, a flat (e.g., 2D) E ink sheet may be integrated onto the external surfaces of a table, or monument having a complex 3D surface. Integrating a 2D E ink sheet onto the 3D surface may include several steps including but not limited to converting a 3D model of the surface into a flat pattern, cutting (e.g., via a laser) E ink sheets (e.g., first display device 104) based on the flat pattern to generate a wrap that can wrap at least partially around the 3D surface, adhering the wrap around the 3D surface (e.g., via adhesive or vacuum), and make the necessary voltage connections (e.g., to a first controller 106).

Another method for integrating the first display device onto a 3D surface includes at least one or more steps of measuring the surface of the first cabin component 101 that needs to be covered with the first display device 104. Use iterative design methods to cover the 3D surface using first display devices 104 (e.g., equal-sized display devices), joining the first display devices 104 while adhering the first display screens onto the 3D surface, and making the necessary voltage connections.

In some embodiments, the first display device 104 includes one or more blank areas that either do not include microcapsules or include only transparent microcapsules. For example, the cabin may include areas on a surface (e.g., such as a no-smoking sign on a wall) that are not to be used for displaying an image or veneer. Instead of cutting out the area not to be displayed from the first display device 104, the first display device 104 may be designed with the blank area, allowing the area to be covered but not obscured. The blank areas of the first display device 104 would ease the design and connectivity requirements of the first display device 104 as there would be less need to terminate the first display device 104 the borders of non-displayed area, resulting in a smaller number of first display devices and fewer connectivity points.

In some embodiments, the one or more processors 108 are configured to determine the identity of a passenger and/or change the image (e.g., veneer) or color of the image based on the preferred (e.g., predetermined preferred) image/color of the passenger. For example, the passenger may be identified via one or more of inclusion in a flight manifest computer file, a passenger input of their identity into an aircraft user interface, a biometric device (e.g., fingerprint or retinal scanner), or scanning of a barcode, QR code, or other symbol that identifies the passenger. Information regarding the passenger's identity may then be transmitted to the one or more processors 108. The one more processors 108 may then, via a lookup table or other processor-involved process, determine the appropriate/preferred image/color scheme for the vehicle interior.

In embodiments, a veneer (e.g., pattern, text, or image) is displayed, via an input (e.g., from the one or more processors 108 or from a manual input) from the aircraft or aircraft personnel. For example, the aircraft or aircraft personnel may provide informational input such as the destination information, nature of work information, or emergency information as described above. For instance, during an emergency, a pilot may change the veneer to display emergency information or instructions, as shown in FIG. 3B.

In embodiments, the one or more processors 108 are configured to use, train, and/or obtain artificial intelligence (AI) and/or machine learning (ML) models to determine the image/color of the image displayed on the first cabin component 101. For example, the one or more processors 108 may receive outputs (e.g., passenger output data), such as passenger identification and/or passenger identifiers (e.g., age, gender, culture, home address, place of origin, passenger alertness, passenger status). Using these output values an AI/ML learning technique may be used to train a model configured to determine the preferred or predicted preferred image or image color for the first cabin component 101. For example, the trained AI/ML model may be trained using supervised techniques, such as a K-Fold cross-validation technique or a logistic regression model technique. A K-Fold cross-validation technique may be used to identify the best model for a given set of problems, in which an input dataset is divided into K subsets and based on the output, a best-fit model is chosen. A logistic regression model is a category of regression model, that may be used for problems in which for a given set of inputs, output is a discrete or binary value. In another example, the trained AI/ML model is trained via unsupervised techniques including, but not limited to, clustering, association, rules, and dimensionality reduction.

The trained AI/ML model can be used solely to identify the passenger (the identity being used to determine the veneer image/color) to identify the passenger, and a status of the passenger, or to identify the status of the passenger without knowledge of the identity of the passenger. For example, the trained AI/ML model may receive the identify the passenger and information that the passenger has been traveling for several hours from an earlier flight and may be tired, causing the AI/ML model to choose a favorite veneer color/image/pattern that is muted (e.g., not bright). In another example, the trained AI/ML model may receive information that a nonidentified passenger is sleeping, causing the AI/ML model to choose a muted or dark veneer.

In embodiments, the trained AI/ML model may determine information that needs to be displayed to the passenger, and then change the veneer to display that information. For example, the trained AI/ML model may determine information (e.g., destination information, nature of work information, or emergency information/instructions) that the passenger need to be made aware of, and then change the veneer of one or more first cabin components 101 to display that information. For instance, the trained AI/ML model may determine or infer that the aircraft has made an emergency landing, and then display on a first cabin component 101 (e.g., the table 308), a directional arrow pointing toward the nearest exit.

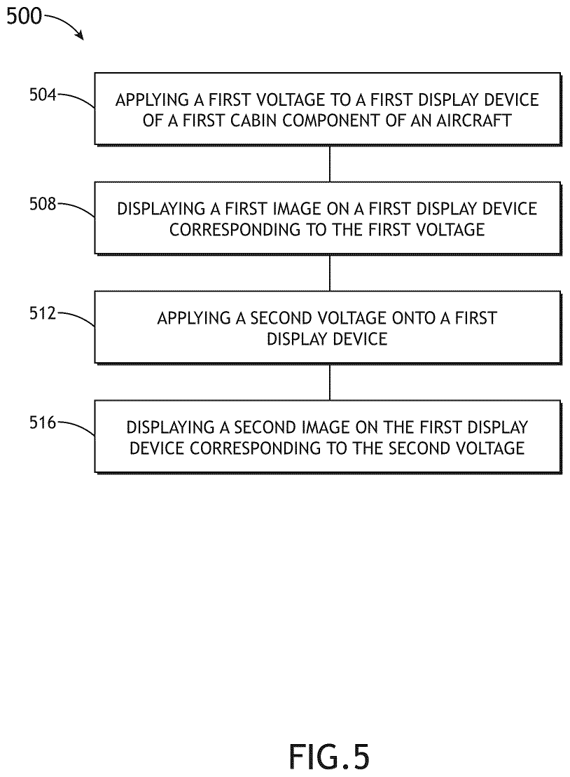

In embodiments, a method 500 for changing the image (e.g., veneer) upon a first cabin component 101 is disclosed, as illustrated in FIG. 5. In embodiments, the method 500 includes a step 504 of applying a first voltage to the first display device 104 of the first cabin component 101 of an aircraft. For example, the operator may, via a user interface device 214 communicatively to the first controller 106 or main controller 210, cause the first controller 106 or main controller 210 to apply the first voltage (e.g., the first voltage data correlated to the first image).

In embodiments, the method 500 includes a step 508 of displaying a first image on a first display device corresponding to the first voltage. In embodiments, the method 500 includes a step 512 of applying a second voltage onto a first display device 104 (e.g., via the user interface device 214). In embodiments, the method 500 includes a step 516 of displaying a second image (e.g., a second veneer image) on the first display device 104 corresponding to the second voltage. (e.g., the first voltage data correlated to the first image). In embodiments, the method may include obtaining a trained artificial intelligence (AI) model and/or machine learning (ML) model, and, based on passenger output data, infer a veneer image, color, or pattern to replace the current veneer (e.g., infer the second image and replace the first image with the second image).

In some embodiments, the method includes a step of, before applying the first voltage, transmitting the first voltage data corresponding to the first image to the first controller 106, main controller 210, or user interface device 214. For example, an operator may input first data voltage wirelessly (e.g., via Bluetooth), or via a memory device (e.g., a USB memory device) into the user interface device 214, which then transfers the first voltage data to the main controller 210 or first controller 106.

While implementations of the method 500 are discussed herein, it is further contemplated that various steps of the method 500 may be included, excluded, rearranged, and/or implemented in many ways without departing from the essence of the present disclosure. Accordingly, the foregoing embodiments and implementations of the method 500 are included by way of example only and are not intended to limit the present disclosure in any way.

The one or more processors 108 of controller 106, 206, 210 may include any one or more processing elements known in the art. In this sense, the one or more processors 108 may include any microprocessor-type device configured to execute software algorithms and/or instructions. In embodiments, the one or more processors 108 may consist of a desktop computer, mainframe computer system, workstation, image computer, parallel processor, or other computer system (e.g., networked computer) configured to execute a program configured to operate the system 100, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non-transitory memory medium 110. Moreover, different subsystems of the system 100 may include a processor or logic elements suitable for carrying out at least a portion of the steps described throughout the present disclosure.

The memory medium 110 may include any memory medium known in the art suitable for storing program instructions executable by the associated one or more processors 108. For example, the memory medium 110 may include, but is not limited to, a read-only memory, a random-access memory, a magnetic or optical memory device (e.g., disk), a magnetic tape, a solid-state drive and the like. In embodiments, the memory medium 110 is configured to store one or more inputs/outputs from the system 100 (e.g., first controller 106, second controller 206, main controller 210, user interface device 214) and/or the output of the various data processing steps described herein. It is further noted that memory medium 110 may be housed in a common controller housing with the one or more processors 108. In an alternative embodiment, the memory medium 110 may be located remotely with respect to the physical location of the processors and controller 106, 206, 210. For instance, the one or more processors 108 of controller 106, 206, 210 may access a remote memory (e.g., server), accessible through a network (e.g., internet, intranet and the like).

It is further noted that, while FIGS. 1-2 depicts the controller 106, 206, 210 as being embodied separately from the first display device 104 and first cabin component 101, such a configuration of system 100 is not a limitation on the scope of the present disclosure, but is provided merely for illustrative purposes. For example, the controller 106, 206, 210 may be embodied within the first cabin component 101, the first external surface 102, and/or first display device 104.

The user interface device 214 may include any user interface known in the art. For example, the user interface may include, but is not limited to, a keyboard, a keypad, a screen, a touchscreen, a lever, a knob, a scroll wheel, a track ball, a switch, a dial, a sliding bar, a scroll bar, a slide, a handle, a touch pad, a paddle, a steering wheel, a joystick, a bezel input device or the like.

All of the methods described herein may include storing results of one or more steps of the method embodiments in a memory medium. The results may include any of the results described herein and may be stored in any manner known in the art. The memory medium may include any memory medium described herein or any other suitable memory medium known in the art. After the results have been stored, the results can be accessed in the memory medium and used by any of the method or system embodiments described herein, formatted for display to a user, used by another software module, method, or system, etc. Furthermore, the results may be stored “permanently,” “semi-permanently,” temporarily,” or for some period of time. For example, the memory medium may be random access memory (RAM), and the results may not necessarily persist indefinitely in the memory medium.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable and/or wirelessly interacting components, and/or logically interacting and/or logically interactable components.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. A system comprising:
a first cabin component for an interior of an aircraft comprising:
a first external surface;
a first display device integrated into the first external surface; and
a first controller electrically coupled to the first display device, wherein the first controller comprises one or more processors configured to execute program instructions stored in memory, wherein the program instructions are configured to cause the one or more processors to:
apply a first voltage to the first display device, wherein the first display device displays a first image corresponding to the first voltage; and
apply a second voltage to the first display device, wherein the first display device displays a second image corresponding to the second voltage.

2. The system of claim 1, further comprising:
a second cabin component for the interior of the aircraft comprising:
a second external surface, the second external surface comprising a second display device integrated into the second external surface; and
a second controller electrically coupled to the second display device, wherein the second controller comprises one or more processors configured to execute program instructions stored in memory, wherein the program instructions are configured to cause the one or more processors to:
apply the first voltage to the second display device, wherein the second display device displays the first image corresponding to the first voltage; and
apply the second voltage to the second display device, wherein the second display device displays the second image corresponding to the second voltage.

3. The system of claim 2, further comprising a main controller coupled to the first controller and the second controller, the main controller comprising one or more processors configured to execute program instructions stored in memory, wherein the program instructions are configured to cause the one or more processors to:
transmit first voltage data correlated to the first image to the first controller; and
transmit second voltage data correlated to the second image to the second display device.

4. The system of claim 2, further comprising a user interface device configured to transfer first voltage data and second voltage data.

5. The system of claim 2, wherein the first cabin component is a table, wherein the second cabin component is a cabinet.

6. The system of claim 1, wherein the first cabin component satisfies Federal Aviation Requirements 14 C.F.R. § 25.853 and corresponding Appendix F.

7. The system of claim 1, wherein the first display device integrated into the first external surface satisfies Federal Aviation Requirements 14 C.F.R. § 25.853 and corresponding Appendix F.

8. The system of claim 7, wherein satisfying Federal Aviation Requirements 14 C.F.R. § 25.853 and corresponding Appendix F comprises being self-extinguishing when tested vertically.

9. The system of claim 7, wherein satisfying Federal Aviation Requirements 14 C.F.R. § 25.853 and corresponding Appendix F comprises having an average burn length not exceeding 6 inches when tested vertically.

10. The system of claim 7, wherein satisfying Federal Aviation Requirements 14 C.F.R. § 25.853 and corresponding Appendix F comprises having an average flame time after removal of a flame source not exceeding 15 seconds when tested vertically.

11. The system of claim 7, wherein satisfying Federal Aviation Requirements 14 C.F.R. § 25.853 and corresponding Appendix F comprises having drippings that do not continue to flame for more than 3 seconds after falling when tested vertically.

12. The system of claim 1, wherein the second image comprises an emergency exit instruction.

13. The system of claim 1, wherein the program instructions are configured to identify a passenger and cause the one or more processors to change the first image to the second image based on a predetermined preferred image of the passenger.

14. The system of claim 1, wherein the program instructions are configured to cause the one or more processors to obtain a trained artificial intelligence (AI) model and/or machine learning (ML) model and, based on passenger output data, infer the second image.

15. The system of claim 14, wherein the trained artificial intelligence (AI) model and/or machine learning (ML) model is configured to recognize an emergency landing, and display a second image that includes an emergency instruction.

16. A method comprising:
applying a first voltage to a first display device of a first cabin component of an aircraft;
displaying a first image on a first display device corresponding to the first voltage;
applying a second voltage onto a first display device; and
displaying a second image on the first display device corresponding to the second voltage.

17. The method of claim 16, further comprising, before applying the first voltage, transmitting a first voltage data corresponding to the first image to a first controller or a user interface device.

18. The method of claim 17, wherein transmitting the first voltage data comprises transmitting the first voltage data wirelessly.

19. The method of claim 16, further comprising obtaining a trained artificial intelligence (AI) and/or machine learning (ML) model, and, based on passenger output data, infer the second image.

20. The method of claim 19, wherein the trained artificial intelligence (AI) and/or machine learning (ML) model, and, based on aircraft data, infer that an emergency landing has been made, and infer the second image as an emergency instruction.
